(19) United States
(12) Patent Application Publication
(10) Pub. No.: US 2026/0166504 A1
(43) Pub. Date: Jun. 18, 2026

(54) AGITATOR MIXER

(71) Applicant: REICA CO., LTD., Miyazaki (JP)

(72) Inventor: Toru TANIGUCHI, Miyazaki (JP)

(21) Appl. No.: 19/412,730

(22) Filed: Dec. 8, 2025

(30) Foreign Application Priority Data
Dec. 12, 2024 (JP) 2024-217626

(51) Int. Cl. B01F 35/92; B01F 31/44; B01F 31/441; B01F 35/90

(52) U.S. Cl. CPC B01F 35/92; B01F 31/441; B01F 31/449; B01F 2035/98

(57) ABSTRACT

[Purpose]

To provide an agitator mixer having a high cooling effect.

[Solution to Achieving Purpose]

The agitator mixer according to the present invention is provided with: an agitation plate F that is attached to a shaft 2 which can reciprocate; a casing 1 that contains the agitation plate; and a cooling means (FP10-23) for cooling a wall surface 11 of the casing that faces a main surface of the agitation plate, and is characterized in that the wall surface in close proximity to at least the cooling means has an area that is perpendicular to the reciprocation direction, and the agitation plate that faces the area is parallel to the area and has a plurality of penetrating holes h created therein.

### TECHNICAL FIELD

The present invention relates to an agitator mixer for agitating and mixing a material or materials.

### BACKGROUND ART

As shown in Patent Literature 1 and 2, an agitator mixer having a shaft and an agitation plate attached thereto in a container in such a manner that the agitation plate can be reciprocated in the direction of the shaft when materials within the container are mixed has been proposed as a conventional agitator mixer for agitating and mixing different materials.

Such an agitator mixer is shown in FIG. 1, which is a simplified schematic diagram, where an agitation plate (vibration plate) F that is attached to a shaft 2 is arranged within a container 1 so that the agitation plate F can be reciprocated in the upward and downward directions as denoted by the arrow A by means of a driving means 20. In FIG. 1, two types of materials (M1, M2) are introduced into the container 1 as materials to be agitated and mixed, and thus, the mixed material MX is discharged.

In the case where a plurality of agitation plates F is reciprocated, it is possible to provide a partition member 10 that protrudes inwards within the container 1 between each pair of adjacent agitator plates F to enhance the effects of agitation and mixing.

FIG. 2 shows the arrangement of one agitation plate F attached to a shaft 2 within a container 1. In FIG. 2, two types of materials (M1, M2) are introduced into the container 1 as materials to be agitated and mixed; however, the configuration may allow one material (either M1 or M2) to be introduced into the container 1 so as to be agitated uniformly.

The agitation plate(s) F shown in FIGS. 1 and 2 has (have) the main surface that spreads in parallel to the plane that is perpendicular to the direction in which the shaft 2 reciprocates; however, as shown in Patent Literature 1, various types of agitation plates having a surface that inclines relative to, and thus, is not perpendicular to, the shaft 2 or having a body that itself is in helical form, for example, are known.

In addition, as shown in Patent Literature 1, the side of the casing that forms a container (the side that is parallel to the direction in which the shaft reciprocates) is cooled in accordance with a method for cooling the agitated and mixed materials. As shown in FIG. 3, Patent Literature 1 also discloses that a coolant is introduced into a partition member 10 that is provided in the container (casing) 1 so as to protrude inwards.

As shown in FIG. 1 or 3, for example, the materials within the container (casing) 1 only reciprocate minutely in the direction A together with the movement of the agitation plate F that is in the same direction A even when the side of the container that is parallel to the direction A in which the shaft 2 reciprocates is cooled. Therefore, it takes a long time for the materials that have been cooled along the side of the container to diffuse uniformly throughout the entirety of the inside of the container 1.

Though it is possible to directly cool the portion of the materials that contacts on the cooled side of the casing 1, the cooling efficiency lowers unless the thermal conductivities of the materials themselves are high when the other portions of the materials are cooled via the cooled portion of the materials. In addition, the cooling effects are further applied to the portion of the materials that contacts on the cooled side as compared to the portions of the materials that are located away from the side, and therefore, the temperature of only the portion of the materials in close proximity to the side extremely lowers, which ends up in a state where the portions of the materials that are away from the proximity of the side are barely cooled temperature-wise. In the case where the materials are solidified, or crystals or the like precipitate as a result of cooling, a thin congelation layer is formed on the side of the container. Thus, it becomes difficult to efficiently cool the portions of the materials that are located further inside even when the side is kept being cooled because the congelation layer has the effects of blocking the thermal conduction. Here, the congelation layer not only means a state where the materials are completely frozen but, in some cases, also means a state where the temperature of a portion of the materials in close proximity to the surface of the side is extremely lower than that of the portions of the materials that are located away from the side.

Moreover, in the case where a partition member 10 is cooled inside the container as shown in Patent Literature 1, the cooling effects are high in close proximity to the portion of the partition member 10 in which the cooling means is arranged; however, sufficient cooling effects cannot be expected in a location that is away from the cooling means unless a material having a high thermal conductivity is used for the partition member. In the same manner as the cooling from the side of the container (casing), a congelation layer is also formed on the surface of the partition member, which makes it difficult to bring about sufficient cooling effects on the materials to be agitated and mixed.

### CITATION LIST

### Patent Literature

[PTL 1]
Japanese Patent No. 5773683
[PTL 2]
Japanese Patent No. 5156466

### SUMMARY OF THE INVENTION

### Technical Problem

An object of the present invention is to solve the above-described problems so as to provide an agitator mixer having high cooling effects.

### Solution to Problem

In order to achieve the above-described object, the agitator mixer according to the present invention has the following technical features.
(1) An agitator mixer is provided with: an agitation plate that is attached to a shaft which can reciprocate; a casing that contains the agitation plate; and a cooling means for cooling either a wall surface of the casing that faces a main surface of the agitation plate or a surface of a partition member that is provided within the casing, and is characterized in that the wall surface or the surface of a partition member has an area that is perpendicular to the direction in which the shaft reciprocates at least in close proximity to the cooling means, and the agitation plate that faces the area is parallel to the area and has a plurality of penetrating holes created therein.
(2) The agitator mixer according to the above (1) is characterized in that a flow path through which a coolant can pass is created in a wall of the casing or inside a partition member as the cooling means.
(3) The agitator mixer according to either the above (1) or (2) is characterized in that the cooling means is provided in a sidewall of the casing that is parallel to the direction in which the shaft reciprocates.

### Advantageous Effects of the Invention

According to the present invention, an agitator mixer is provided with: an agitation plate that is attached to a shaft which can reciprocate; a casing that contains the agitation plate; and a cooling means for cooling either a wall surface of the casing that faces a main surface of the agitation plate or a surface of a partition member that is provided within the casing, and is characterized in that the wall surface or the surface of a partition member has an area that is perpendicular to the direction in which the shaft reciprocates at least in close proximity to the cooling means, and the agitation plate that faces the area is parallel to the area and has a plurality of penetrating holes created therein, and therefore, the formation of a congelation layer on the wall surface or on the surface of the partition member due to the cooling means is suppressed in close proximity to the cooling means, which thus makes it possible to enhance the cooling effects onto the materials to be agitated and mixed.

Even in the case where a congelation layer has been formed or is being formed, the agitated materials collide onto the wall surface or the surface of the partition member as the agitation plate moves, and thereby, the cooled materials are removed off from the wall surface or from the surface of the partition member. When the agitation plate moves, in particular, the materials are jetted at a high speed through the penetrating holes that are created in the agitation plate in the direction opposite to that in which the agitation plate moves. As a result, the materials that have been jetted through the penetrating holes collide fiercely onto the wall surface or onto the surface of the partition member, and removes the cooled materials such as those in the form of a congelation layer off from an area that is in close proximity to the wall surface or the like, which makes it possible to efficiently cool the entirety of the materials within the container.

### BRIEF DESCRIPTION OF DRAWINGS

FIG. 1 is a schematic diagram showing a conventional agitator mixer;

FIG. 2 is a schematic diagram showing another conventional agitator mixer;

FIG. 3 is a schematic diagram showing an example of an agitator mixer provided with a cooling means;

FIG. 4 is a cross-sectional diagram showing an example of an agitator mixer according to the present invention;

FIG. 5 is a cross-sectional diagram showing another example of an agitator mixer according to the present invention;

FIGS. 6A and 6B are schematic diagrams showing the connection state from among the respective flow paths in the cooling means in FIG. 4;

FIG. 7 is a cross-sectional diagram showing still another example of an agitator mixer according to the present invention;

FIG. 8 is a diagram showing an example of an agitation plate that is used for an agitator mixer according to the present invention;

FIG. 9 is a diagram showing the movement state (part 1) of the materials within the casing in the agitator mixer in FIG. 5;

FIG. 10 is a diagram showing the movement state (part 2) of the materials within the casing in the agitator mixer (where a cooling means is arranged on the wall surface on the lower side) in FIG. 5;

FIG. 11 is a diagram showing the movement state (part 1) of the materials within the casing in the agitator mixer in FIG. 7; and

FIG. 12 is a diagram showing the movement state (part 2) of the materials within the casing in the agitator mixer in FIG. 7.

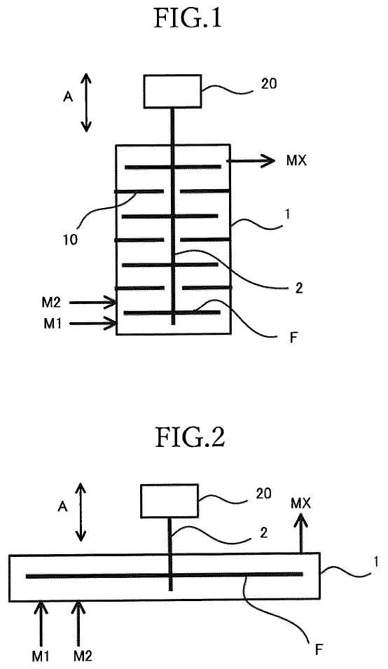

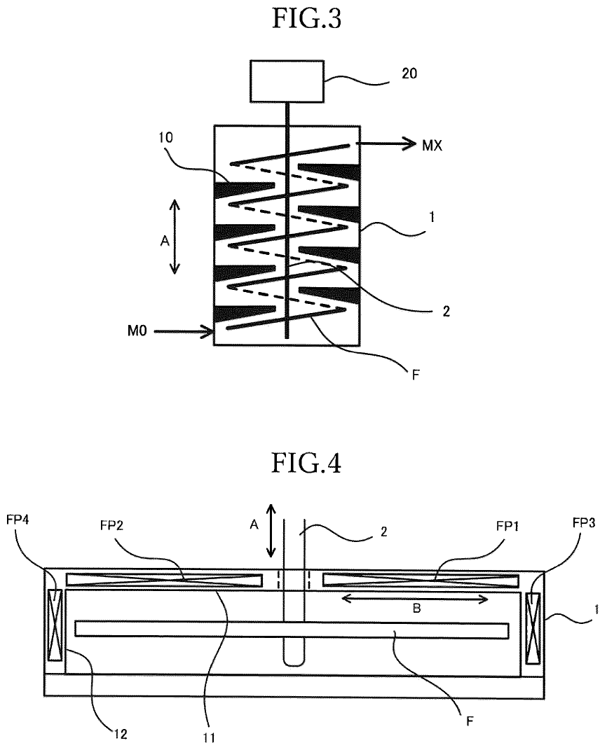

### DESCRIPTION OF EMBODIMENTS

In the following, an agitator mixer according to the present invention is described in reference to FIGS. 4 through 13.

The agitator mixer according to the present invention is provided with: an agitation plate F that is attached to a shaft 2 which can reciprocate; a casing 1 that contains the agitation plate; and a cooling means (FP1, FP2, and so forth) for cooling either a wall surface of the casing that faces a main surface of the agitation plate or a surface of a partition member 10 that is provided within the casing, and is characterized in that the wall surface or the surface of a partition member has an area that is perpendicular to the direction in which the shaft reciprocates at least in close proximity to the cooling means, and the agitation plate that faces the area is parallel to the area and has a plurality of penetrating holes h created therein.

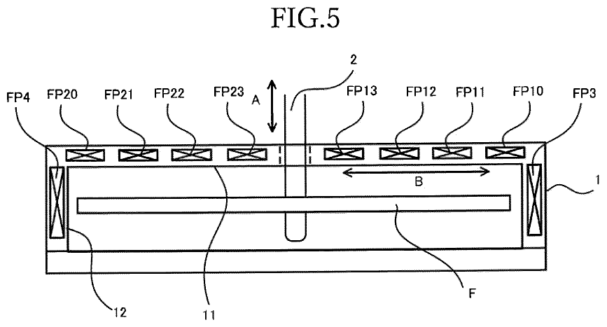

The agitator mixer according to the present invention is described in detail below. FIGS. 4 and 5 are cross-sectional diagrams showing an agitator mixer having one agitation plate F as in FIG. 2 in the case where a cooling means is provided in the agitator mixer. In FIG. 4, one flow path (FP1, FP2) in torose form, or in C shaped disc form is provided as a cooling means for cooling the wall surface (jacket plate) 11 that faces the agitation plate F in the casing 1 and is arranged in such a manner as to surround the shaft 2. In addition, a flow path (FP3, FP4) is provided in the sidewall of the casing and is arranged in such a manner as to surround the agitation plate F. The flow path (FP3, FP4) may be one flow path or may be divided into a plural. Coolants may be separately put into or taken out from the flow path (FP1, FP2) and the flow path (FP3, FP4).

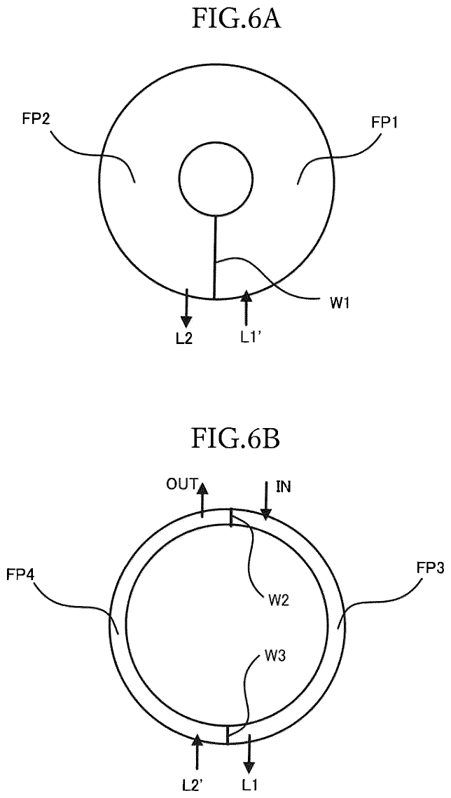

As shown in FIGS. 6A and 6B, the flow path (FP1, FP2) and the flow path (FP3, FP4) may partially be communicated so as to form one flow path. FIG. 6A is a plan diagram showing the flow path (FP1, FP2) as viewed from the top. FIG. 6B is a plan diagram showing the flow path (FP3, FP4) as viewed from the top. In further detail, a partition W2 is provided in a portion of the flow path (FP3, FP4) in FIG. 6B, and an entrance (IN) and an exit (OUT) for the coolants are created. Furthermore, another partition W3 is provided in the middle of the flow path (FP3, FP4), and a connection flow path for communicating the flow from the arrow L1 to the arrow L1′ in FIG. 6A is provided so that the coolant can be supplied to the flow path FP1. The flow path (FP1, FP2) in FIG. 6A is created in C shape with the partition W1, and another connection flow path for allowing the coolant to move from the arrow L2 to the arrow L2′ in FIG. 6B is provided. Thus, one flow path for allowing the flow FP3→FP1(FP2) →FP4 is formed.

Naturally, the method for connecting the flow path (FP1 through FP4) is not limited to the example in FIGS. 6A and 6B, and it is also possible to provide a greater number of partitions to form a flow path that runs between the flow path (FP1, FP2) on the wall surface side and the flow path (FP3, FP4) on the sidewall side a number of times. Here, it needs to be taken into account that the greater the number of times the flow path runs between the wall surface side and the sidewall side is, the higher the pressure is when the coolant flows.

It is possible to construct the flow path (FP10 through FP20) for cooling the wall surface 11 in FIG. 5 as one flow path in spiral form; however, it is also possible to construct this one flow path as four flow paths in concentric circular form where a partition is provided in a portion of each circular flow path, and at the same time, a contact flow path is separately provided in order to connect each pair of the adjacent circular flow paths.

Irregularity occurs in the temperature distribution in the direction of the arrow B in the wall surface 11 when the area cooled by the cooling means for cooling the wall surface 11 becomes great in the case where a flow path that spread in disc form is used as in FIG. 4 or even in the case where a flow path constructed by connecting thinner flow paths to each other is used as in FIG. 5. Therefore, unevenness takes place in the temperature of the agitated and mixed, and thus, it also becomes necessary to move the materials in the direction of the arrow B while agitating the materials.

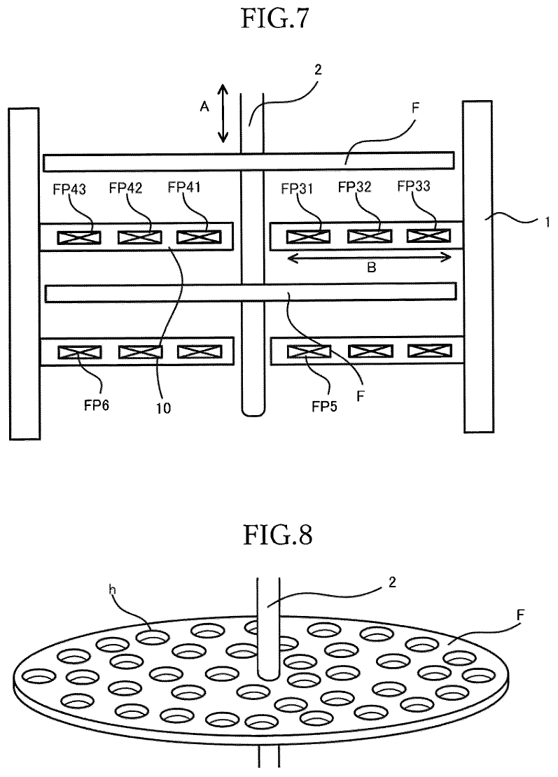

FIG. 7 shows a cooling means for cooling a partition member 10. In the same manner as in FIG. 5, a plurality of flow paths (FP31 through FP43) is shown in the cross-section; however, it is possible for the configuration to provide one flow path where the respective flow paths are linked to each other. It is also possible for each flow path shown in FIG. 7 to be formed of one flow path (FP1, FP2) in torose form or in C shaped disc form as shown in FIG. 4. When the partition member 10 is cooled and the area to be cooled becomes large, there is a possibility of unevenness occurring in the temperature distribution in the direction of the arrow B in the same manner as the cooling of the wall surface 11 in FIGS. 4 and 5.

As described in the explanation of a conventional technology, the materials to be agitated and mixed in the present invention generally have a low thermal conductivity, and therefore, the portions of the materials that contact the surface of the wall in which a cooling means is formed (wall surface 11, for example) are mainly cooled, and the cooling effects lower as the location is further away from the wall surface. In addition, a so-called congelation layer is formed of only the portion of the materials of which the temperature is extremely low in close proximity to the wall surface. In order to suppress the formation of such a congelation layer, and at the same time, in order to solve the problem of unevenness in the temperature distribution in the direction of the arrow B, penetrating holes h are created in the agitation plate F as shown in FIG. 8 in the present invention.

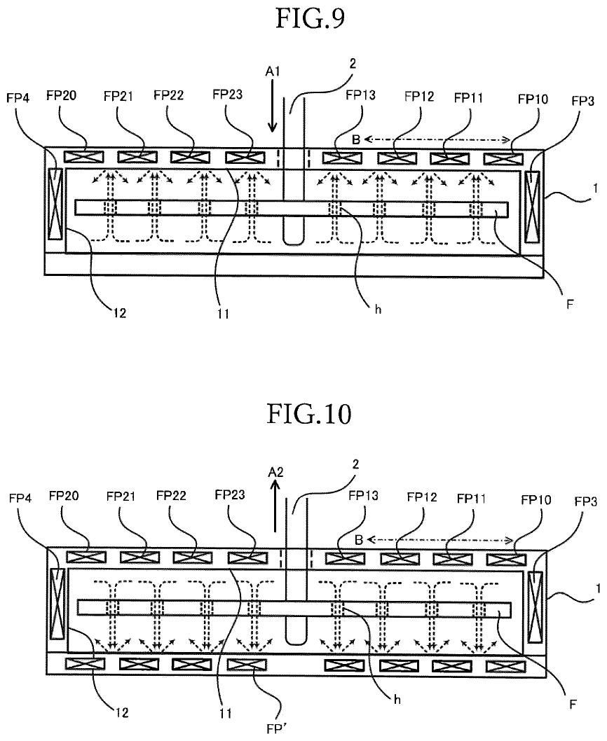

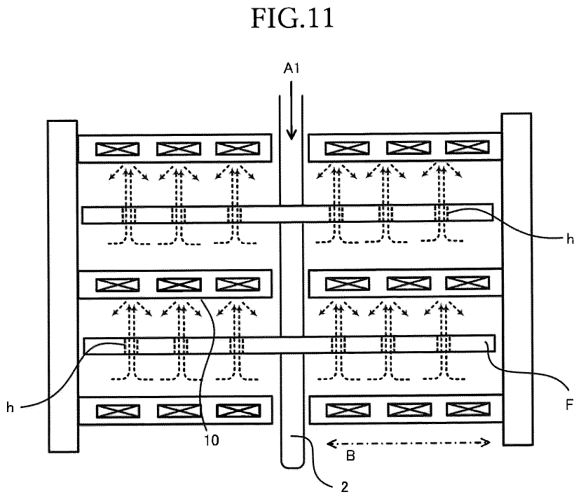

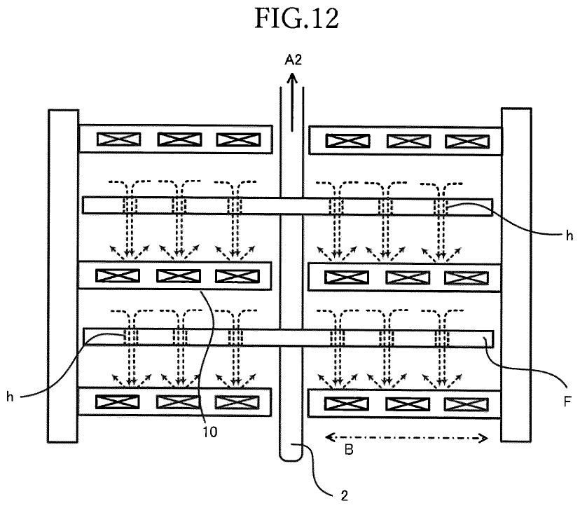

FIGS. 9 and 10 are diagrams showing the movement state (dotted arrows) of the materials in the case where the agitation plate F of the agitator mixer in FIG. 5 is provided with penetrating holes. In addition, FIGS. 11 and 12 are diagrams showing the movement state (dotted arrows) of the materials in the case where the agitation plate F of the agitator mixer in FIG. 7 is provided with penetrating holes.

As shown in FIGS. 9 through 12, movements occur in the portions of the materials within the casing as denoted by the dotted arrows as the agitation plate F moves in the direction of the arrow A1 (downwards in the figure) or in the direction of the arrow A2 (upwards in the figure). Concretely, as shown in FIG. 9, when the agitation plate F moves downwards in the figure (arrow A1), the portions of the materials on the lower side of the agitation plate F move to the upper side of the agitation plate F (move in the direction opposite to the arrow A1) via the penetrating holes h in the agitation plate F. When the agitation plate F moves at a high speed, the materials are fiercely jetted out through the penetrating holes h, collide onto the surface 11 of the wall in which a cooling means is arranged, and remove from the wall surface the congelation layer that has been formed in close proximity to the wall surface. The removed materials diffuse throughout the inside of the casing together with the materials that had collided onto the wall surface 11, have been reflected therefrom and spread in the direction of the arrow B (in the lateral directions in the figure, including the frontward and backward directions relative to the figure).

When the materials jet out from the penetrating holes h, or when the materials fiercely collide onto the wall surface 11, complicated vortexes are generated, which thus brings about the effects of efficiently removing the cooled materials from the proximity to the wall surface and accelerating the mixture of the removed portions of the materials with the other portions thereof.

As described above, the same materials are prevented from staying in close proximity to the cooling means due to the effects of the movements (dotted arrows) of portions of the materials through the penetrating holes h, which makes it difficult for a congelation layer to be formed. In addition, unevenness in the temperature of the materials is dissolved as the materials diffuse in the direction of the arrow B even when the temperature becomes uneven in the wall surface 11 in the direction of the arrow B.

FIG. 10 shows the movement state of the materials in the case where the agitation plate F of the agitator mixer in FIG. 9 moves in the opposite direction (in the direction of the arrow A2). Here, FIG. 10 shows an example of the agitator mixer where a cooling means (a flow path FP′) is provided in the wall on the lower side of the casing. When the agitation plate F moves in the upward direction in the figure, which is the direction of the arrow A2, the materials on the upper side of the agitation plate F move to the lower side of the agitation plate F via the penetrating holes h in the agitation plate F. When the agitation plate F moves at a high speed, as described in reference to FIG. 9, the materials are fiercely jetted out through the penetrating holes h towards the wall surface on the lower side, removes the cooled materials from the proximity to the wall surface, and allows the removed materials to diffuse throughout the inside of the casing.

FIGS. 11 and 12 are diagrams showing the movement state of the materials when the agitation plates F of the agitator mixer in FIG. 7 are provided with penetrating holes. FIG. 11 shows the case where the agitation plates F have moved in the direction of the arrow A1 (downwards in the figure), and at this time, the materials are fiercely jetted out from the lower side of the respective agitation plates F through the penetrating holes h in the agitation plates F in the opposite direction (upwards in the figure). These jetted-out materials collide onto a partition member 10 and yield the effects of removing the portions of the materials that have been cooled by the cooling means in the partition member 10 from the surface of the partition member.

FIG. 12 shows the case where the agitation plates F have moved in the direction of the arrow A2 (upwards in the figure), and at this time, the materials are jetted out from the upper side of the respective agitation plates F through the penetrating holes h in the direction opposite to the direction in which the agitation plates F move (downwards in the figure). Like the descriptions in reference to FIG. 11, the collision of the materials onto the partition members causes the removal of the portions of the materials that have been cooled in close proximity to the surface of the partition members off from the surface of the partition members, and the removed portions of the materials diffuse through the inside of the casing.

In order to enhance the effects of cooling the entirety within the casing in the agitator mixer according to the present invention, it is necessary for a wall 11 and a partition member 10 in which a cooling means is provided to have an area that is perpendicular to the direction of the arrow A (direction of the shaft) in which an agitation plate F reciprocates (area that is parallel to the direction of the arrow B). This is because portions of the materials jet out through the penetrating holes in the direction opposite to the direction in which an agitation plate F moves when the agitation plate F has moved in the direction of the arrow A (arrows A1 or A2 in FIGS. 9 through 12) during the reciprocation, and the impact force caused by the collision of the jetted-out materials onto a wall surface or a partition member becomes the maximum on an area that is perpendicular to direction of the arrow A (direction of the shaft), which is the direction of jetting. In the case where such areas are provided in such a manner as to incline rather than being perpendicular, the materials shift along the inclination of the areas at the time of collision onto the areas, and thus, the impact of the materials applied to the areas cannot be maximized. As a result, it becomes difficult to sufficiently remove the materials that have been cooled by a cooling means and stay in close proximity to the areas. In the case where an area is inclined, the collided materials are reflected mainly in a predetermined directions in accordance with the inclination of the area, and therefore, the effects of uniform diffusion in the direction of the arrow B as shown in FIGS. 9 through 12 cannot be expected. Accordingly, it takes a longer time for the entirety of the materials within the casing to be cooled to a uniform temperature.

As shown in FIGS. 9 through 12, it is also preferable for the main surface of an agitation plate F to be perpendicular to the reciprocation direction A of the agitation plate. This is because the speed of the materials that are jetted out through the penetrating holes of an agitation plate can be maximized (the maximum jetting-out speed is set at 1 m/s or greater, for example), and thus, the impact force of collision onto a wall surface 11 or a partition member 10 can be made greater. In the case where an agitation plate is arranged so as to incline relative to the perpendicular direction of the arrow A as shown in Patent Literature 1 or 2, the materials have a momentum in the direction denoted by the arrow B as the agitation plate F reciprocates, which makes it difficult to allow the materials to be efficiently jet out through the penetrating holes.

Accordingly, it is preferable for the inner surface of a wall 11 that faces an agitation plate F or the surface of a partition member 10 that faces an agitation plate F to have an area that is perpendicular to the arrow A (A1, A2), which is the reciprocation direction (direction of the shaft) of the agitation plate, and at the same time, for the area to be set to be parallel to the main surface of the agitation plate.

Furthermore, Patent Literature 1 discloses the creation of penetrating holes in a partition member 10. When penetrating holes are created in a partition member in which a cooling means is formed, however, the cooling effects on the materials located within the penetrating holes are enhanced, which makes it easier for a congelation layer to be formed along the inner walls of the penetrating holes. Such a congelation layer that is formed within a penetrating hole is different from a congelation layer that is formed on the surface of a partition member (the surface that faces an agitation plate) in that the impact force of the materials required to remove the congelation layer is greater within a penetrating hole. Thus, it becomes necessary to reciprocate the agitation plate F more fiercely.

As a result, it is not very preferable to create a penetrating hole in a partition member 10. In the case where penetrating holes are to be created, some measures need to be taken such that penetrating holes are provided in a location that is sufficiently away from the flow path of the cooling means, or the size of the penetrating holes is made greater than usual.

The above descriptions are centered on the cooling means in agitator mixers; however, it is possible for the cooling means not only to be used for the cooling within the agitator mixer but also to be used as a means for setting and adjusting the temperature of the materials within the agitator mixer to a predetermined temperature. Concretely, it is possible for the configuration to allow a heating medium of which the temperature has been adjusted to flow through a flow path that is provided in the cooling means (a flow path through which a coolant passes or a flow path that is provided separately from the coolant flow path, for example). Furthermore, it is possible to use the same material for the heating medium and the coolant. Moreover, it is possible to incorporate an electric heater as a heating means separately from the cooling means of the agitator mixer.

### INDUSTRIAL APPLICABILITY

As described above, the present invention makes it possible to provide an agitator mixer having a high cooling effect.

### REFERENCE SIGNS LIST

1 Casing
2 Shaft
10 Partition member
11 Wall surface (a portion of the casing, that is arranged in a location facing an agitation plate)
20 Driving means
F Agitation plate
FP1-43 Flow path

1. An agitator mixer, comprising:
an agitation plate that is attached to a shaft which can reciprocate;
a casing that contains the agitation plate;
a cooling means for cooling either a wall surface of the casing that faces a main surface of the agitation plate or a surface of a partition member that is provided within the casing, characterized in that
the wall surface or the surface of a partition member has an area that is perpendicular to the direction in which the shaft reciprocates at least in close proximity to the cooling means, and
the agitation plate that faces the area is parallel to the area and has a plurality of penetrating holes created therein.

2. The agitator mixer according to claim 1, characterized in that
a flow path through which a coolant can pass is created in a wall of the casing or inside a partition member as the cooling means.

3. The agitator mixer according to claim 1, characterized in that
the cooling means is provided in a sidewall of the casing that is parallel to the direction in which the shaft reciprocates.

4. The agitator mixer according to claim 2, characterized in that
the cooling means is provided in a sidewall of the casing that is parallel to the direction in which the shaft reciprocates.
